(19) United States
(12) Patent Application Publication
(10) Pub. No.: US 2024/0054064 A1
(43) Pub. Date: Feb. 15, 2024

(54) SYSTEM AND METHOD FOR GENERATING A SANDBOX COMPUTING ENVIRONMENT FOR ANALYZING RESOURCE IMPACT

(71) Applicant: BANK OF AMERICA CORPORATION, Charlotte, NC (US)

(72) Inventors: Patrick Warren Higgins, Saint Augustine, FL (US); Karen Lea MacQueen, Lyndhurst, OH (US); Katherine Kei-Zen Dintenfass, Lincoln, RI (US)

(73) Assignee: BANK OF AMERICA CORPORATION, Charlotte, NC (US)

(21) Appl. No.: 17/887,979

(22) Filed: Aug. 15, 2022

(51) Int. Cl. G06F 11/34; G06F 11/30; G06F 9/50

(52) U.S. Cl. CPC G06F 11/3457; G06F 11/301; G06F 9/5077; G06F 2209/508

(57) ABSTRACT

A system is provided for generating a sandbox computing environment for analyzing resource impact. In particular, the system may be configured to display a graphical user interface comprising a virtual environment platform that allows a user to run one or more simulations based on the user's resource position. In this regard, the system may generate a snapshot of a user account associated with a user and execute simulations on the snapshot to provide one or more projections with respect to resources associated with the user account. Each projection may illustrate a potential impact on the resources associated with the user in response to one or more actions or events associated with the resources. In this way, the system provides a secure and efficient way to analyze impacts of actions and/or events on resources.

### FIELD OF THE INVENTION

The present invention embraces a system for generating a sandbox computing environment for analyzing resource impact.

### BACKGROUND

There is a need for an efficient way to analyze resource impact.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for generating a sandbox computing environment for analyzing resource impact. In particular, the system may be configured to display a graphical user interface comprising a virtual environment platform that allows a user to run one or more simulations based on the user's resource position. In this regard, the system may generate a snapshot of a user account associated with a user and execute simulations on the snapshot to provide one or more projections with respect to resources associated with the user account. Each projection may illustrate a potential impact on the resources associated with the user in response to one or more actions or events associated with the resources. The system may further be configured to allow users to share the generated snapshots and/or projections with other users. In this way, the system provides a secure and efficient way to analyze impacts of actions and/or events on resources.

Accordingly, embodiments of the present disclosure provide a system for generating a sandbox computing environment for analyzing resource impact, the system comprising at least one non-transitory storage device; and at least one processor coupled to the at least one non-transitory storage device, wherein the at least one processor is configured to receive, from a first endpoint device, a request to access a simulation portal over a network; present a graphical user interface of the simulation portal on a display device of the first endpoint device; receive, from the first endpoint device, a request to generate a simulation on a resource account associated with the first endpoint device, wherein the request to generate the simulation comprises one or more simulated actions and a timeframe parameter; generate a snapshot of the resource account associated with the first endpoint device, wherein the snapshot comprises a resource amount associated with the resource account and a timestamp; and generate the simulation based on the snapshot of the resource account, the one or more simulated actions, and the timeframe parameter.

In some embodiments, generating the simulation further comprises presenting results of the simulation on the graphical user interface on the first endpoint device.

In some embodiments, generating the simulation is further based on one or more external events associated with the resource account.

In some embodiments, the simulation portal is further configured to receive a request to execute the one or more simulated actions on the resource account; and automatically execute the one or more simulated actions on the resource account.

In some embodiments, the simulation portal is further configured to receive an approval from a second endpoint device before automatically executing the one or more simulated actions on the resource account.

In some embodiments, the simulation portal is further configured to receive a request to share results of the simulation with one or more trusted users; and present the results of the simulation on one or more endpoint devices associated with the one or more trusted users.

In some embodiments, the simulation portal is further configured to receive a request to view results of a second simulation run by a trusted user; and present the results of the second simulation on the graphical user interface on the first endpoint device.

Embodiments of the present disclosure also provide a computer program product for generating a sandbox computing environment for analyzing resource impact, the computer program product comprising a non-transitory computer-readable medium comprising code causing an apparatus to receive, from a first endpoint device, a request to access a simulation portal over a network; present a graphical user interface of the simulation portal on a display device of the first endpoint device; receive, from the first endpoint device, a request to generate a simulation on a resource account associated with the first endpoint device, wherein the request to generate the simulation comprises one or more simulated actions and a timeframe parameter; generate a snapshot of the resource account associated with the first endpoint device, wherein the snapshot comprises a resource amount associated with the resource account and a timestamp; and generate the simulation based on the snapshot of the resource account, the one or more simulated actions, and the timeframe parameter.

In some embodiments, generating the simulation further comprises presenting results of the simulation on the graphical user interface on the first endpoint device.

In some embodiments, generating the simulation is further based on one or more external events associated with the resource account.

In some embodiments, the simulation portal is further configured to receive a request to execute the one or more simulated actions on the resource account; and automatically execute the one or more simulated actions on the resource account.

In some embodiments, the simulation portal is further configured to receive an approval from a second endpoint device before automatically executing the one or more simulated actions on the resource account.

In some embodiments, the simulation portal is further configured to receive a request to share results of the simulation with one or more trusted users; and present the results of the simulation on one or more endpoint devices associated with the one or more trusted users.

Embodiments of the present disclosure also provide a computer-implemented method for generating a sandbox computing environment for analyzing resource impact, the computer-implemented method comprising receiving, from a first endpoint device, a request to access a simulation portal over a network; presenting a graphical user interface of the simulation portal on a display device of the first endpoint device; receiving, from the first endpoint device, a request to generate a simulation on a resource account associated with the first endpoint device, wherein the request to generate the simulation comprises one or more simulated actions and a timeframe parameter; generating a snapshot of the resource account associated with the first endpoint device, wherein the snapshot comprises a resource amount associated with the resource account and a timestamp; and generating the simulation based on the snapshot of the resource account, the one or more simulated actions, and the timeframe parameter.

In some embodiments, generating the simulation further comprises presenting results of the simulation on the graphical user interface on the first endpoint device.

In some embodiments, generating the simulation is further based on one or more external events associated with the resource account.

In some embodiments, the simulation portal is further configured to receive a request to execute the one or more simulated actions on the resource account; and automatically execute the one or more simulated actions on the resource account.

In some embodiments, the simulation portal is further configured to receive an approval from a second endpoint device before automatically executing the one or more simulated actions on the resource account.

In some embodiments, the simulation portal is further configured to receive a request to share results of the simulation with one or more trusted users; and present the results of the simulation on one or more endpoint devices associated with the one or more trusted users.

In some embodiments, the simulation portal is further configured to receive a request to view results of a second simulation run by a trusted user; and present the results of the second simulation on the graphical user interface on the first endpoint device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for the system for generating a sandbox computing environment for analyzing resource impact, in accordance with an embodiment of the present disclosure;

FIG. 2 illustrates a process flow for generating a sandbox computing environment for analyzing resource impact, in accordance with an embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may generally refer to physical or virtual objects that may be used to accomplish the entity's objectives. In this regard, the resources may include computing resources such as processing power, memory allocation, cache space, storage space, data files, network connections and/or bandwidth, electrical power, input/output functions, and the like, or data files (e.g., document files, media files, system files, and/or the like). In other embodiments, resources may refer to financial resources such as funds or digital currencies, where such resources may be linked to an account associated with a user.

The present disclosure provides a system for generating a sandbox computing environment for analyzing resource impact. In this regard, the sandbox computing environment may comprise a virtual platform accessible over a network through one or more computing devices associated with one or more users. The virtual platform may, when accessed by the one or more computing devices, present a graphical user interface on the computing devices, where the graphical user interface may allow the user to access the various functions of the virtual platform. By accessing the virtual platform, users may execute various simulations on a resource account associated with the user, where the resource account may be associated with one or more resources. To this end, the system may generate a snapshot of the resource account of the user, where the snapshot comprises one or more parameters associated with the resource account of the user at a designated point in time. The one or more parameters may include information such as the amount of resources within the resource account of the user, the resource types associated with the resource account, historical resource transfer data associated with the resource account, current status of the resource account, and/or the like.

Based on the snapshot and one or more simulated actions inputted by the user, the system may generate one or more simulations with respect to one or more resources associated with the resource account of the user. In this regard, the system may determine the impacts and/or effects of the one or more simulated actions on the resource account and/or the resources associated with the resource account, where the simulated actions may include resource transfers, resource reallocations, and/or the like. In some embodiments, the simulations may further be based on one or more external events associated with the resource account, where the external events may have another impact and/or effect on the resources and/or resource account associated with the user.

In some embodiments, the system may comprise a networked platform that may be configured to present a graphical user interface on a display device of a user computing device, where the platform may allow the user to specify simulated actions and/or view the results of the simulations generated by the system. In some embodiments, the user may further specify a timeframe parameter for running the simulation, wherein the timeframe parameter defines the length of time between the timestamp of the snapshot, which is taken to be the starting point, and an endpoint of the simulation. For instance, the user may wish to see the results of the simulated actions and/or external events on the resource account in 5 years starting from the time the snapshot was generated. The network platform may further be configured to allow the user to share the snapshot and/or the simulations with other trusted users and view the snapshots and/or simulations that other users have shared with the user. In some embodiments, the platform may further allow the user and/or a second user associated with the user to execute the simulated actions on the actual resource account based on the generated simulations. In this way, the system provides a secure and efficient way for a user to review and compare simulations based on the user's resource account.

An exemplary embodiment is provided as follows. It should be understood that the following example is provided for illustrative purposes only and is not intended to restrict or limit the scope of the disclosure herein. In an exemplary embodiment, a first user may be a child or dependent of a second user (who may be a parent or guardian of the first user). The first user may hold an account (e.g., checking, savings, investment, or the like) with an entity such as a financial institution, where the account may be associated with certain resources (e.g., funds of a certain type of currency). Accordingly, the first user may wish to simulate the effects of certain actions and/or events on the user's one or more accounts (e.g., actions such as investing, saving, spending, and/or the like, along with events such as taxes and/or other obligations). The system may begin by generating a current snapshot of the user's various accounts. In some embodiments, the system may generate snapshots on an on-demand basis (e.g., whenever the user access the platform). In other embodiments, the system may periodically and continuously generate and/or update snapshots of the resource accounts at designated intervals (e.g., every hour, every minute, or the like). In some embodiments, the system may store multiple snapshots of the user's accounts at various points in time (e.g., the system stores not only a current snapshot, but historical snapshots that reflect the states of the user's accounts at a designated time in the past). As such, the system may further allow the first user to examine hypothetical scenarios regarding what types of changes would have been realized if the user had taken certain alternative actions in the past.

The first user may then input one or more simulated actions and/or a timeframe parameter for the purpose of generating the simulation. For instance, the first user may wish to see the effects of investing in a specified amount of resources in a savings account for five years. Accordingly, the system may generate the simulation based on the simulated actions, timeframe, and the snapshot of the user's account at a given point in time. Once the simulation has been generated, the system may display the results of the simulation on a graphical interface on a computing device associated with the first user (e.g., a smartphone of the first user). The results of the simulation may show the effects of the simulated actions over the desired timeframe (e.g., the system may show the increase in resources based on the investment at the 5-year point starting from the timestamp of the snapshot). The first user may run additional simulations based on any configuration of simulated actions, and further share/view simulations with other users within the platform, thereby allowing the first user to determine an optimal strategy for managing resources through the various simulations. For any given simulation, the first user (e.g., with approval of the second user) may implement the actions specified by the simulated actions on the real-world account of the first user. In this way, the system may allow users to effectively and expediently manage resources based on the simulations provided by the system.

The present disclosure provides a technical solution to the technical problem of optimizing resource allocations Specifically, the technical solution presented herein provides a way to use simulations on resource accounts to provide projections of certain simulated actions on the resource account, thereby providing the user with an efficient and expedient way to manage resources.

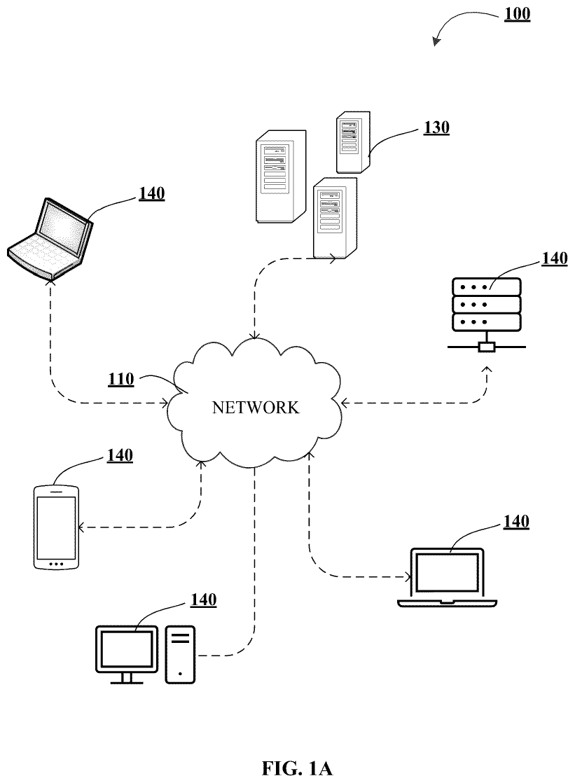

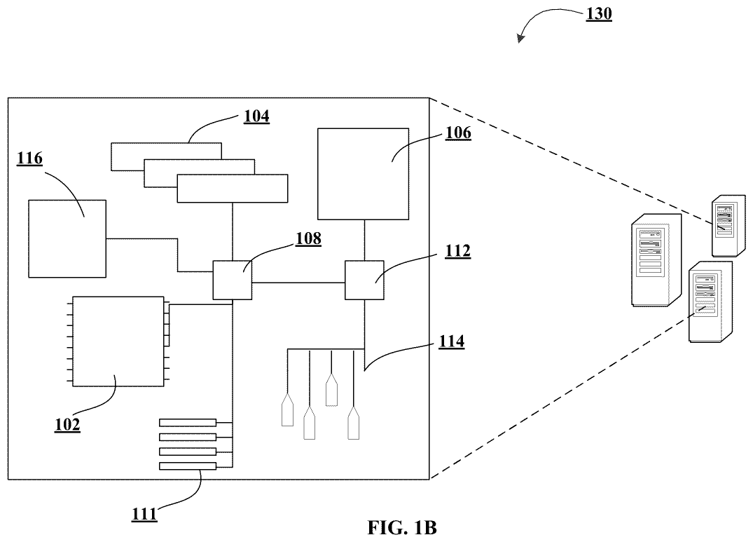

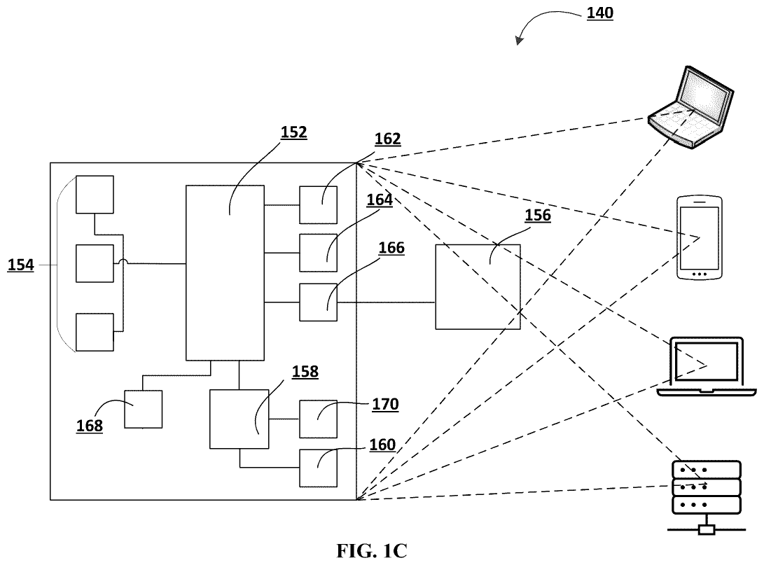

FIGS. 1A-1C illustrate technical components of an exemplary distributed computing environment 100 for the system for generating a sandbox computing environment for analyzing resource impact, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

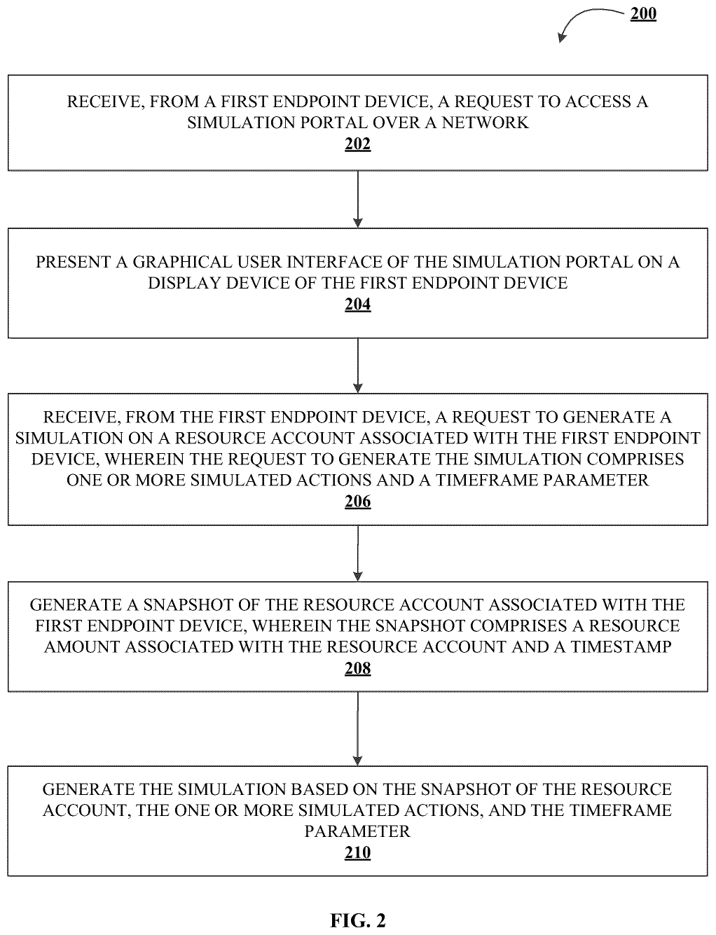

FIG. 2 illustrates a process flow 200 for generating a sandbox computing environment for analyzing resource impact, in accordance with an embodiment of the present disclosure. The process begins at block 202, where the system receives, from a first endpoint device, a request to access a simulation portal over a network. The simulation portal may be, for instance, a server accessible through the Internet by one or more endpoint devices. Accordingly, in some embodiments, the first endpoint device may transmit the request to access the portal through an application installed on the first endpoint device that may be provided by an entity (e.g., a financial institution). In other embodiments, the application may be a web browser that may be used on the first endpoint device to access a web page hosted on the server. In an exemplary embodiment, the first endpoint device may be used by a first user to access a sandbox environment for running financial simulations on the first user's resource accounts. In such an embodiment, the first user may request to log onto the simulation portal hosted by the entity's servers, where the request to log on may comprise a set of authentication credentials associated with the first user (e.g., a username and password, biometric data, and/or the like). Once the system has successfully authenticated the first user, the system may proceed to the next step.

The process continues to block 204, where the system presents a graphical user interface of the simulation portal on a display device of the first endpoint device. The graphical user interface may comprise one or more interface elements for displaying information to the user and/or receiving inputs from the user. The one or more interface elements may comprise interactable elements (e.g., text entry fields, clickable or activatable buttons or areas, radio buttons, drop-down menus, radial wheels, and/or the like) and non-interactable elements (e.g., text boxes, graphs, charts, diagrams, and/or the like) that may be used to present information related to the simulations to the user.

The process continues to block 206, where the system receives, from the first endpoint device, a request to generate a simulation on a resource account associated with the first endpoint device, wherein the request to generate the simulation comprises one or more simulated actions and a timeframe parameter. The first user may input the one or more simulated actions and/or the timeframe parameter through the interface elements of the graphical user interface. In an exemplary embodiment, the timeframe parameter may be selected by the user through text entry fields, while the one or more simulated actions may be selected through a drop down menu. The one or more simulated actions may relate to certain types of financial activity that the first user may take with respect to the resources within the resource account associated with the first user. Accordingly, examples of the one or more simulated actions may include executing a resource transfer to a recipient, making a purchase, transferring resources to an investment account, and/or the like. In an exemplary embodiment, the first user may wish to see the simulated results of allocating a set amount of resources into a particular investment over a 10 year period. In such an embodiment, the user may select the type and mount of investment within the one or more simulated actions and set the timeframe parameter to 10 years.

The process continues to block 208, where the system generates a snapshot of the resource account associated with the first endpoint device, wherein the snapshot comprises a resource amount associated with the resource account and a timestamp. The snapshot of the resource account may reflect the state of the one or more resource accounts associated with the first user at a particular point in time as defined by the timestamp. The timestamp may serve as the starting point for the simulation. To this end, the timeframe parameter may define its starting point based on the timestamp associated with the snapshot. The snapshot of the resource account may include the amount and/or type of resources within the resource account, historical data regarding the resource account (e.g., past transactions, deposits, and/or the like), and/or the like.

The process continues to block 210, where the system generates the simulation based on the snapshot of the resource account, the one or more simulated actions, and the timeframe parameter. Generating the simulation may comprise computing and analyzing the effect of the simulated actions on the resource account and/or the resources associated with the resource account over a timeframe as defined by the timeframe parameter. Continuing the above example, the system may compute the effect of the simulated actions (e.g., depositing resources into an investment account) based on various simulated factors, such as interest rates, amount of resources deposited, compounding equations, expected market conditions, and/or the like. In some embodiments, generating the simulation may further be based on one or more external events associated with the resource account. For instance, the investment may be affected by events such as tax events, dividends, and other types of events that may affect the value of the investment. Once the simulation has been generated, the system may present the results of the simulation on the graphical user interface of the simulation portal.

In some embodiments, the system may be configured to allow the first user to execute the simulated actions on the resource account of the user. To illustrate, the first user may decide that, based on reviewing the simulation within the simulation portal, that the proposed investment is an optimal use of resources. In such an embodiment, the first user may submit a request to execute the simulated actions on the resource account. Upon receiving the request, the system may automatically execute the simulated actions on the resource account (e.g., the system may transfer the designated amount of resources into the investment account). In some embodiments, the system may require that a second user (e.g., a parent or guardian of the first user) provide an approval of the simulated actions before executing the simulated actions on the resource account.

In some embodiments, the simulation portal may be configured to allow the user to select one or more trusted users for the purpose of sharing the results of the simulation. In such an embodiment, the system may present the results of the simulation on the endpoint devices associated with the trusted users. The simulation portal may further be configured to allow the user to view the results of simulations run by the trusted users. In such an embodiment, upon receiving a request from the first user to view a simulation from a trusted user, the system may present the simulation from the trusted user on the graphical user interface on the first endpoint device.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for generating a sandbox computing environment for analyzing resource impact, the system comprising:
at least one non-transitory storage device; and
at least one processor coupled to the at least one non-transitory storage device, wherein the at least one processor is configured to:
receive, from a first endpoint device, a request to access a simulation portal over a network;
present a graphical user interface of the simulation portal on a display device of the first endpoint device;
receive, from the first endpoint device, a request to generate a simulation on a resource account associated with the first endpoint device, wherein the request to generate the simulation comprises one or more simulated actions and a timeframe parameter;
generate a snapshot of the resource account associated with the first endpoint device, wherein the snapshot comprises a resource amount associated with the resource account and a timestamp;
generate the simulation based on the snapshot of the resource account, the one or more simulated actions, and the timeframe parameter;
retrieve a historical snapshot of the resource account associated with the first endpoint device, wherein the historical snapshot represents a state of the resource account at a past point in time; and
generate a historical simulation based on the historical snapshot of the resource account and a second set of simulated actions, wherein the historical simulation comprises changes to the resource account associated with the first endpoint device if the second set of simulated actions had been executed at the past point in time.

2. The system of claim 1, wherein generating the simulation further comprises presenting results of the simulation on the graphical user interface on the first endpoint device.

3. The system of claim 1, wherein generating the simulation is further based on one or more external events associated with the resource account.

4. The system of claim 1, wherein the simulation portal is further configured to:
receive a request to execute the one or more simulated actions on the resource account; and
automatically execute the one or more simulated actions on the resource account.

5. The system of claim 4, wherein the simulation portal is further configured to receive an approval from a second endpoint device before automatically executing the one or more simulated actions on the resource account.

6. The system of claim 1, wherein the simulation portal is further configured to:
receive a request to share results of the simulation with one or more trusted users; and
present the results of the simulation on one or more endpoint devices associated with the one or more trusted users.

7. The system of claim 1, wherein the simulation portal is further configured to:
receive a request to view results of a second simulation run by a trusted user; and
present the results of the second simulation on the graphical user interface on the first endpoint device.

8. A computer program product for generating a sandbox computing environment for analyzing resource impact, the computer program product comprising a non-transitory computer-readable medium comprising code causing an apparatus to:
receive, from a first endpoint device, a request to access a simulation portal over a network;
present a graphical user interface of the simulation portal on a display device of the first endpoint device;
receive, from the first endpoint device, a request to generate a simulation on a resource account associated with the first endpoint device, wherein the request to generate the simulation comprises one or more simulated actions and a timeframe parameter;
generate a snapshot of the resource account associated with the first endpoint device, wherein the snapshot comprises a resource amount associated with the resource account and a timestamp;
generate the simulation based on the snapshot of the resource account, the one or more simulated actions, and the timeframe parameter;
retrieve a historical snapshot of the resource account associated with the first endpoint device, wherein the historical snapshot represents a state of the resource account at a past point in time; and
generate a historical simulation based on the historical snapshot of the resource account and a second set of simulated actions, wherein the historical simulation comprises changes to the resource account associated with the first endpoint device if the second set of simulated actions had been executed at the past point in time.

9. The computer program product of claim 8, wherein generating the simulation further comprises presenting results of the simulation on the graphical user interface on the first endpoint device.

10. The computer program product of claim 8, wherein generating the simulation is further based on one or more external events associated with the resource account.

11. The computer program product of claim 8, wherein the simulation portal is further configured to:
receive a request to execute the one or more simulated actions on the resource account; and
automatically execute the one or more simulated actions on the resource account.

12. The computer program product of claim 10, wherein the simulation portal is further configured to receive an approval from a second endpoint device before automatically executing the one or more simulated actions on the resource account.

13. The computer program product of claim 8, wherein the simulation portal is further configured to:
receive a request to share results of the simulation with one or more trusted users; and
present the results of the simulation on one or more endpoint devices associated with the one or more trusted users.

14. A computer-implemented method for generating a sandbox computing environment for analyzing resource impact, the computer-implemented method comprising:
receiving, from a first endpoint device, a request to access a simulation portal over a network;
presenting a graphical user interface of the simulation portal on a display device of the first endpoint device;
receiving, from the first endpoint device, a request to generate a simulation on a resource account associated with the first endpoint device, wherein the request to generate the simulation comprises one or more simulated actions and a timeframe parameter;
generating a snapshot of the resource account associated with the first endpoint device, wherein the snapshot comprises a resource amount associated with the resource account and a timestamp;
generating the simulation based on the snapshot of the resource account, the one or more simulated actions, and the timeframe parameter;
retrieving a historical snapshot of the resource account associated with the first endpoint device, wherein the historical snapshot represents a state of the resource account at a past point in time; and
generating a historical simulation based on the historical snapshot of the resource account and a second set of simulated actions, wherein the historical simulation comprises changes to the resource account associated with the first endpoint device if the second set of simulated actions had been executed at the past point in time.

15. The computer-implemented method of claim 14, wherein generating the simulation further comprises presenting results of the simulation on the graphical user interface on the first endpoint device.

16. The computer-implemented method of claim 14, wherein generating the simulation is further based on one or more external events associated with the resource account.

17. The computer-implemented method of claim 14, wherein the simulation portal is further configured to:
receive a request to execute the one or more simulated actions on the resource account; and
automatically execute the one or more simulated actions on the resource account.

18. The computer-implemented method of claim 17, wherein the simulation portal is further configured to receive an approval from a second endpoint device before automatically executing the one or more simulated actions on the resource account.

19. The computer-implemented method of claim 14, wherein the simulation portal is further configured to:
receive a request to share results of the simulation with one or more trusted users; and
present the results of the simulation on one or more endpoint devices associated with the one or more trusted users.

20. The computer-implemented method of claim 14, wherein the simulation portal is further configured to:
receive a request to view results of a second simulation run by a trusted user; and
present the results of the second simulation on the graphical user interface on the first endpoint device.
